(19) United States
(12) Patent Application Publication
(10) Pub. No.: US 2018/0012166 A1
(43) Pub. Date: Jan. 11, 2018

(54) METHOD AND SYSTEM FOR DETERMINING FORECASTS

(71) Applicant: Pluto7 Consulting Inc., Milpitas, CA (US)

(72) Inventors: Manjunath DEVADAS, Milpitas, CA (US); Salil AMONKAR, Milpitas, CA (US)

(21) Appl. No.: 15/642,903

(22) Filed: Jul. 6, 2017

Related U.S. Application Data
(60) Provisional application No. 62/359,662, filed on Jul. 7, 2016.

(51) Int. Cl. G06Q 10/06; G06Q 30/02

(52) U.S. Cl. CPC G06Q 10/06315; G06Q 10/067; G06Q 30/0206

(57) ABSTRACT

Embodiments provide method and systems for determining business transaction forecast. The method includes receiving plurality of input data streams from multiple sources. The plurality of input data streams includes at least one of demand information and supply information associated with a business entity for which the business transaction forecast is to be determined. The method further includes determining one or more business transaction patterns in the plurality of input data streams. A forecast model is determined from among a plurality of forecast models upon determination of the one or more business transaction patterns, wherein the forecast model provides highest accuracy of the business transaction forecast among the plurality of forecast models. The method includes providing a business transaction forecast output generated based on the forecast model to a processing device of the business entity.

### TECHNICAL FIELD

The present disclosure generally relates to determining forecasts and, more particularly to methods and systems for determining forecast in a continuous, automatic and accurate manner from various types of data inputs obtained different sources.

### BACKGROUND

One of the most important tasks in supply-chain management is improving forecast accuracy. Enterprises or businesses need to improve forecast accuracy of their demand so that they can plan the right amount of supply and thereby improve profitability. Forecasting in business will help predict product demand so that enough products are available to fulfil customer orders with short lead times.

Forecasting ensures that manufacturers produce the level of material that would sufficiently meet customer's demand. Since investment in inventory is tied to the supply-chain management, determining forecast accuracy is critical. FIG. 13 (prior art) is an example representation of a plot 1300 illustrating a business scenario of supply and demand. If the supply is higher than the actual demand, then there will be a surplus supply leading to wastage of the shelf stocks and resources, because it adds to the cost of keeping the high inventory and other resources. If the supply is lower than the demand, then it leads to loss because customer demands cannot be fulfilled. Hence, it is desired that the demand forecast is determined more accurately and constantly. Also, pricing of the product and/or services is also linked to demand and supply experienced by business entities.

Currently, there are various existing solutions for determining forecast. However, the existing solutions suffer from one or more drawbacks such as high reliance on human input. Humans' ability to understand the generated forecast and to come up with improvement tasks are limited by the time and ability to get into the mathematical calculation on a daily basis. Forecast accuracy varies by the amount of information and input being generated constantly. The existing solutions do not take in machine data into feedback since it is too overwhelming for them to input constantly generated data to adjust forecast. In addition, the situation worsens in companies that have limited labor to monitor and manage forecast accuracy continuously. Further, visually it is hard for people to comprehend the impact of forecast inaccuracy.

Therefore, there is a need for improved techniques for determining forecast (e.g., of demand, supply and pricing) to overcome inability of current forecasting solutions, to effectively manage rapid deviations in the forecast trends over short time periods from multitude of sources, to effectively handle large volume of transactions, and to give relevant and timely business guidance that is crucial for running an operational process.

### SUMMARY

Various embodiments of the present disclosure provide systems, and methods for method for determining a business transaction forecast.

An embodiment provides a method for determining a business transaction forecast. The method includes receiving a plurality of input data streams from one or more sources. The plurality of input data streams comprises at least one of demand information and supply information associated with a business entity for which the business transaction forecast is to be determined. The method further comprises determining one or more business transaction patterns in the plurality of input data streams. A forecast model is determined from among a plurality of forecast models upon determination of the one or more business transaction patterns, wherein the forecast model provides highest accuracy of the business transaction forecast among the plurality of forecast models. The method comprises providing a business transaction forecast output generated based on the forecast model to a processing device of the business entity.

Another embodiment provides a system for determining a business transaction forecast. The system includes a processing unit and a memory. The processing unit is configured to receive a plurality of input data streams from one or more sources. The plurality of input data streams comprises at least one of demand information and supply information associated with a business entity for which the business transaction forecast is to be determined. The processing unit is configured to determine one or more business transaction patterns in the plurality of input data streams. The processing unit further determines a forecast model from among a plurality of forecast models upon determination of the one or more business transaction patterns, wherein the forecast model provides highest accuracy of the business transaction forecast among the plurality of forecast models. The processing unit provides a business transaction forecast output generated based on the forecast model to a processing device of the business entity. The memory is configured to store the plurality of input data streams in a common format in form of denormalized cell structure and a metadata. The memory further stores the plurality of forecast models.

Another embodiment comprises a system for determining business transaction forecast. The system comprises an input data processor, a pattern search multi demand sensor and a multi-dimensional demand supply balancer. The input data processor is configured to receive a plurality of input data streams from one or more sources, the plurality of input data streams comprising at least one of demand information and supply information associated with a business entity for which the business transaction forecast is to be determined. The input data processor further processes at least a portion of the input data into a common format in form of denormalized cell structure and a metadata. The pattern search multi demand sensor is configured to classify the plurality of input data streams into a plurality of clusters based on applying at least one affinity parameter among the plurality of input data streams. The pattern search multi demand sensor further determines one or more business transaction patterns in the plurality of input data streams. The multi-dimensional demand supply balancer iteratively applies the plurality of forecast models on the identified patterns based at least on historical information associated with the identified patterns to select the forecast model providing the highest accuracy.

### BRIEF DESCRIPTION OF THE FIGURES

For a more complete understanding of example embodiments of the present technology, reference is now made to the following descriptions taken in connection with the accompanying drawings in which:

FIG. 1 illustrates an operative environment related to at least some embodiments of the present disclosure;

FIG. 2 is an illustration of a system for accurate forecasting of business transactions, in accordance with an example embodiment;

FIG. 3 illustrates a portion of a system for determining forecast, in accordance with an example embodiment;

FIG. 4 illustrates another portion of the system for determining forecast, in accordance with an example embodiment;

FIG. 5 illustrates yet another portion of the system for determining forecast, in accordance with an example embodiment;

FIG. 6 depicts a plot representing adjusted forecast, in accordance with an example embodiment;

FIG. 7 depicts a schematic representation of a system, in accordance with an example embodiment;

FIG. 8 depicts a plot representing high accuracy output, in accordance with an example embodiment;

FIG. 9 an illustration of a flow diagram of a method for determining business transaction forecast for a business entity, in accordance with an embodiment;

FIG. 10 is a simplified representations of a sequence flow for selecting demand, supply and pricing models, in accordance with an embodiment;

FIG. 11 is another illustration of a flow diagram of a method for determining business transaction forecast;

FIG. 12 depicts a simplified block diagram representation of an example system for determining forecast, in accordance with an example embodiment; and

FIG. 13 is an example representation of a plot illustrating a business problem in prior art.

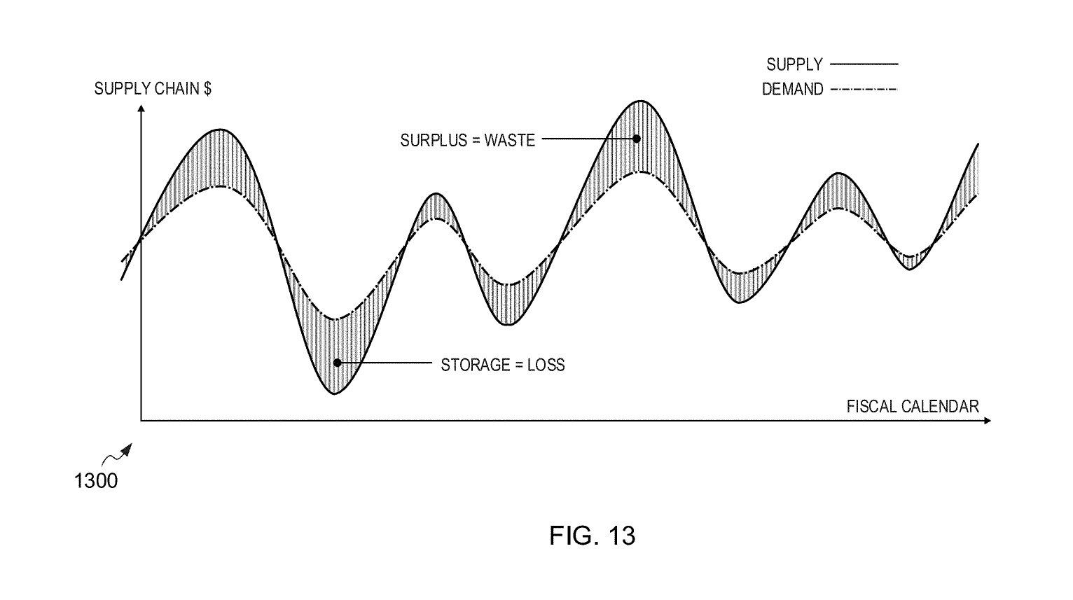

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods and systems for determining business transaction forecast of a business entity.

A system for determining business transaction forecast of a business entity can be used in an operative environment is provided. The system includes a processing unit and a memory. The processing unit comprises an input data processor, a pattern search multi demand sensor and a multi-dimensional demand supply balancer. The input data processor is configured to receive a plurality of input data streams from one or more sources. The input data streams may include human data, machine data, and network traffic data. The plurality of input data streams comprises at least one of demand information and supply information associated with a business entity for which the business transaction forecast is to be determined. The input data processor further processes at least a portion of the input data into a common format in form of denormalized cell structure and a metadata. The denormalized cell structure and a metadata are stored in the memory. The pattern search multi demand sensor classifies the plurality of input data streams into a plurality of clusters based on applying at least one affinity parameter among the plurality of input data streams. One or more business transaction patterns including demand pattern, supply pattern and pricing pattern are determined in the plurality of input data streams. The multi-dimensional demand supply balancer iteratively applies the plurality of forecast models on the identified patterns based at least on historical information associated with the identified patterns. The processing unit further determines a forecast model from among a plurality of forecast models upon determination of the one or more business transaction patterns. The determined forecast model is the forecast model that provides the highest accuracy of the business transaction forecast among the plurality of forecast models. The processing unit provides a business transaction forecast output generated based on the forecast model to a processing device of the business entity. The memory is configured to store the plurality of input data streams in a common format in form of denormalized cell structure and a metadata. The memory further stores the plurality of forecast models.

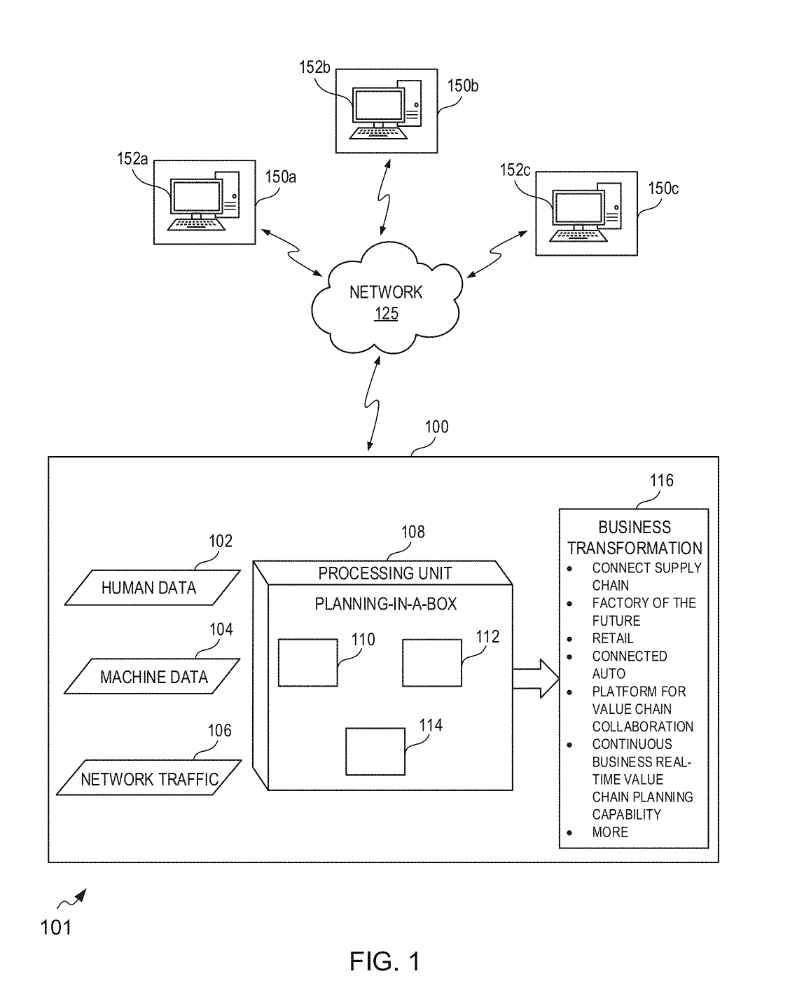

FIG. 1 illustrates a system 100 (planning in a box) for determining business transaction forecast of a business entity, used in an operative environment 101. The environment 101 depicts the system 100 which is responsible for overall enterprise resource planning of a plurality of business entities (e.g. 150a, 150b, and 150c) for which the business transaction forecasts are to be determined. Some representative data processing/computing devices (e.g. 152a, 152b and 152c) of the business entities 150a, 150b and 150c, respectively are shown. Devices used by the business entities (150a, 150b, and 150c) communicate with the system 100 via one or more suitable networks 125. Examples of the one or more networks 125 include, but are not limited to, the Internet, intranet, Bluetooth, Zigbee and other type of wired, wireless or mixed networks.

The system 100 may be configured in a centralized server, or may be operated on a cloud based infrastructure for providing business transaction services to the entities via various communication means such as the network 125. In some configurations, the functionality of the system 100 can be made locally available at data processing devices for example local servers within the business entities. For instance, a system 100 may be instantiated locally on one or more servers of the plurality of business entities (e.g. 150a, 150b, and 150c), and service support can be provided by a central station managing the overall infrastructure of the system 100. It may be noted that the devices 152a, 152b and 152c may be used to provide a plurality of data input streams to determine the business transaction forecast for the entities.

The system 100 includes plurality of input data streams for providing business transaction forecast (hereinafter interchangeably referred to as only ‘forecast’). Some non-exhaustive examples of the input data streams are shown in FIG. 1 as human data 102, machine data 104, and network traffic data 106. The input data streams may include customer data, supplier data and pricing data, among others. The input data streams (e.g., 102, 104, 106) are received from various sources. The input data streams comprise demand information and supply information associated with a business entity for which the forecast is to be generated or determined. The input data streams, received from various sources, also includes pricing information for products or services associated with the business entity. The input data streams may include unstructured data streams and structured data streams or a combination of these. For example, inputs received from human sources or social feeds may be unstructured data, while input data captured from machine sources may be structured data.

The processing unit 108 is capable of converting unstructured raw data into structured data. Human sentiments and behaviors towards various products may be extracted from the input data streams. Input data streams received from machine sources may include data in the form of documents including tables, graphs, etc that provides information about products, suppliers, pricing, time, geography, sale, etc. The input data streams are processed by a processing unit 108 of the system 100. The system 100 includes various demand models 110, supply models 112 and pricing models 114. The demand models (or demand forecasting models) 110 may include cloud based forecasting, data-sciences-driven forecasting, tailored-forecasting models, customer segmentation and the like. The supply models 112 may include cloud based analytics models, data-sciences-driven models, machine learning models, etc. Similarly, the pricing models 114 may include cloud based analytics models, data-sciences-driven models, machine learning models, etc.

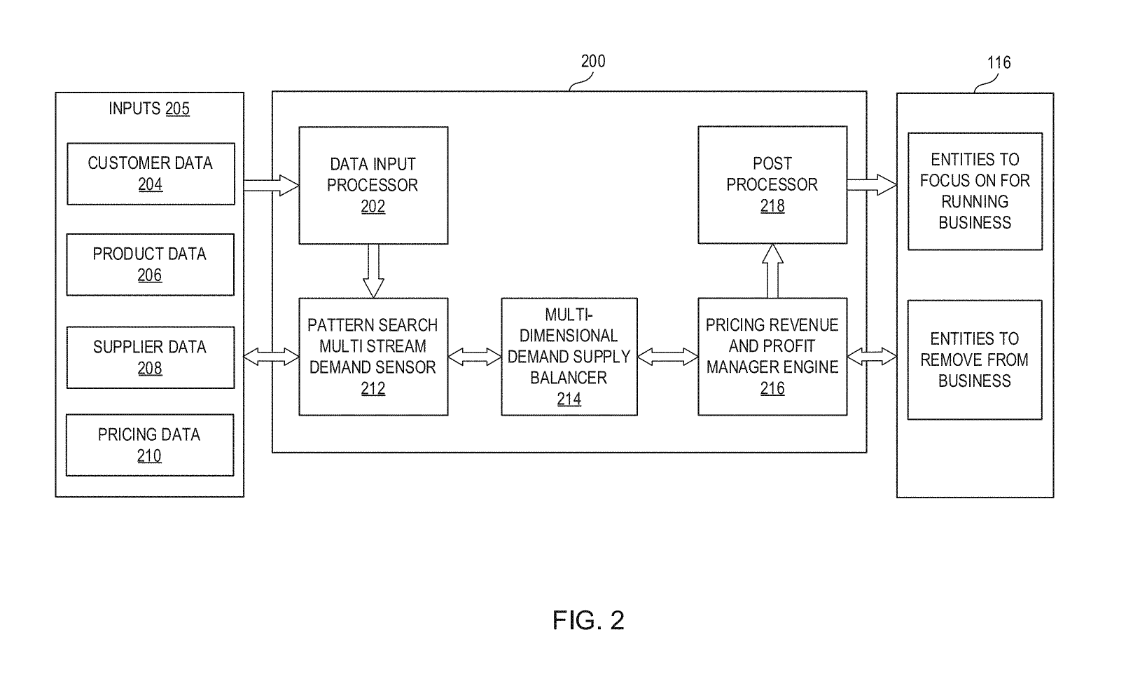

The processing unit 108 uses the models (demand models 110, supply models 112, pricing models 114) to generate business transaction forecast output 116 including one or more of a demand forecast output, a supply forecast output and a pricing forecast output. Examples of demand forecast output, supply forecast output and pricing forecast output may include but not limited to connect supply chain, retail, factory of the future, connected auto, platform for value chain collaboration, continuous business real-time value chain planning capability, which entities to focus on for running business or which entities to remove from business, etc. The processing unit 108 may be a combination of one or more processors with various capabilities, such as processing and converting unstructured raw data into structured data, performing sentiment analysis from multimedia files, pattern searching, pattern matching and pattern recognition, among others. The processing unit 108 is explained in detail in conjunction with, FIGS. 2 to 5.

The system 100 provides the business transaction forecast output 116 to data processing devices (e.g., 152a, 152b and 152c) of the business entities (e.g. 150a, 150b, and 150c). In an example, the system 100 may include a user interface or application for providing output of the processing unit 108 and enabling several workflows via the processing unit 108. The user application may also rest on a remote virtual server, such as a cloud server. The application can be accessed via user devices or administrator devices. Various existing platforms can be used for developing the functionalities of the processing unit 108. Examples of platforms include, but are not limited to, Google® platform, Microsoft® Azure, and the like.

The system 100 may implement what is called a “Forecast accuracy auto pilot” or “auto pilot”. Forecast accuracy auto pilot receives feeds from human and machine data and improves forecast accuracy. Forecast accuracy auto pilot uses vision machine learning to determine any possible signals that can impact demand or supply e.g. human traffic in retail store. Further, forecast accuracy auto pilot uses speech recognition and sentiment analysis to determine if there is a bias in the forecast input (human input). Forecast accuracy auto pilot uses video analytics for signal to determine demand, supply and pricing adjustments. Businesses use the forecast accuracy and then leverage the optimum set of supply and pricing combinations to make automatic changes in demand, supply and pricing related business inputs to maximize revenue, profit and maintain desired service level.

FIG. 2 is a simplified block diagram representation of a system 200 for business transaction forecasting, in accordance with an embodiment. The system 200 is an example of the system 100 and can be embodied on cloud infrastructure, a remote server or within servers of the business entities.

The system 200 includes a data input processor 202, a pattern search multi stream demand sensor 212, a multi-dimensional demand supply balancer 214, a pricing, revenue and profit manager engine 216 and a post processor 218. The system 200 received a plurality of input data streams 205, which may be examples of the input data streams 102, 104 and 106 in various forms. For instance, the input data streams 205 includes customer information 204, product information 206, supplier information 208 and pricing information 210 in form of various data streams. In an example, one data stream may include one or more of the information 204, 206, 208 and 210. The data input processor 202 processes unstructured data to convert them into structured data. A portion of the inputs, for example inputs corresponding to customer information 204, may be received by the data input processor 202 in unstructured form and converted into structured information. In some examples, a portion of the inputs (i.e. the structured input) may be directly received by the pattern search multi stream demand sensor 212, and the processed data (e.g., unstructured data changed into structured data) corresponding to customer information 204 is received by the pattern search multi stream demand sensor 212 from the data input processor 202. The output of the pattern search multi stream demand sensor 212 is used by the multi-dimensional demand supply balancer 214 to look at the demand at various levels and corresponding supply components. Based on the demands and corresponding supply requirements, the pricing revenue and profit manager engine 216 modifies and adjusts the pricings of components. The pricing details are received by the post processor 218 to present the pricing information in a simplified visualization form. The forecast outputs 116 are provided based on pricing details and other factors. In an example, the outputs 116 may include, in human readable format, recommendations as to which entities to focus on for running business or which entities to remove from business. The forecast outputs 116 provide recommendations to a particular business entity regarding how to balance the demand and supply, how to plan for supply for the anticipated demand, and ways to proactively set the pricing of the product/services related to the business entity.

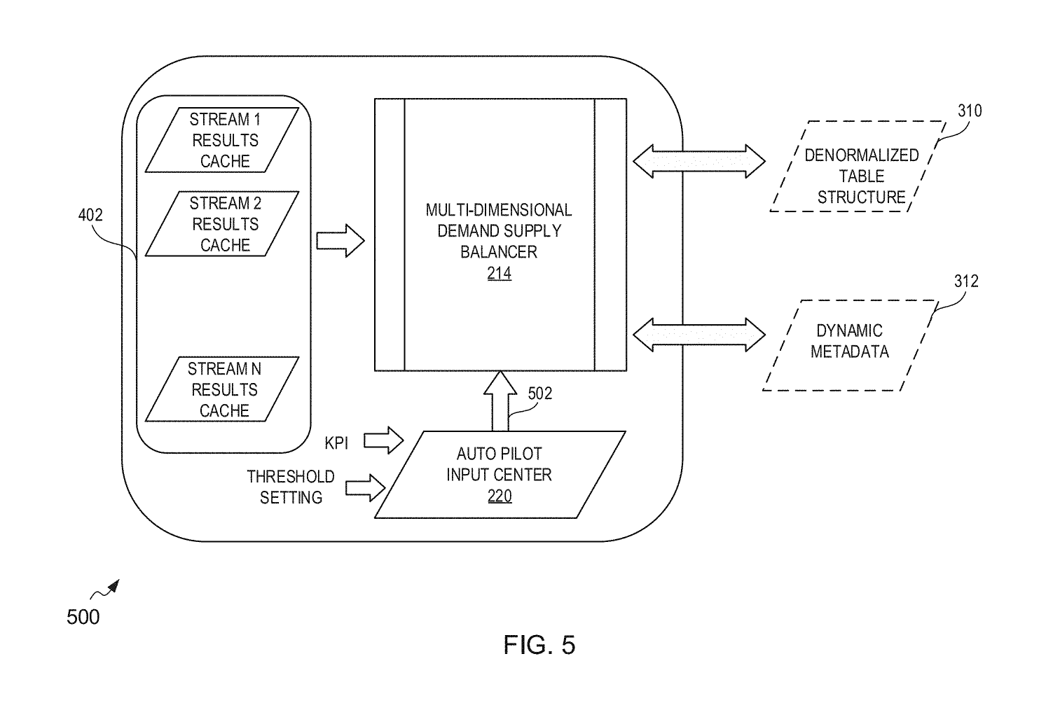

In another embodiment, the system 200 may further include an auto pilot input center 220 (shown in FIG. 5). The system 200 may use input from the auto pilot input center 220 for the best possible set of directives for forecast accuracy. The auto pilot input center 220 may be an artificial intelligence engine comprising a set of instructions and computer codes for determining the forecast accuracy.

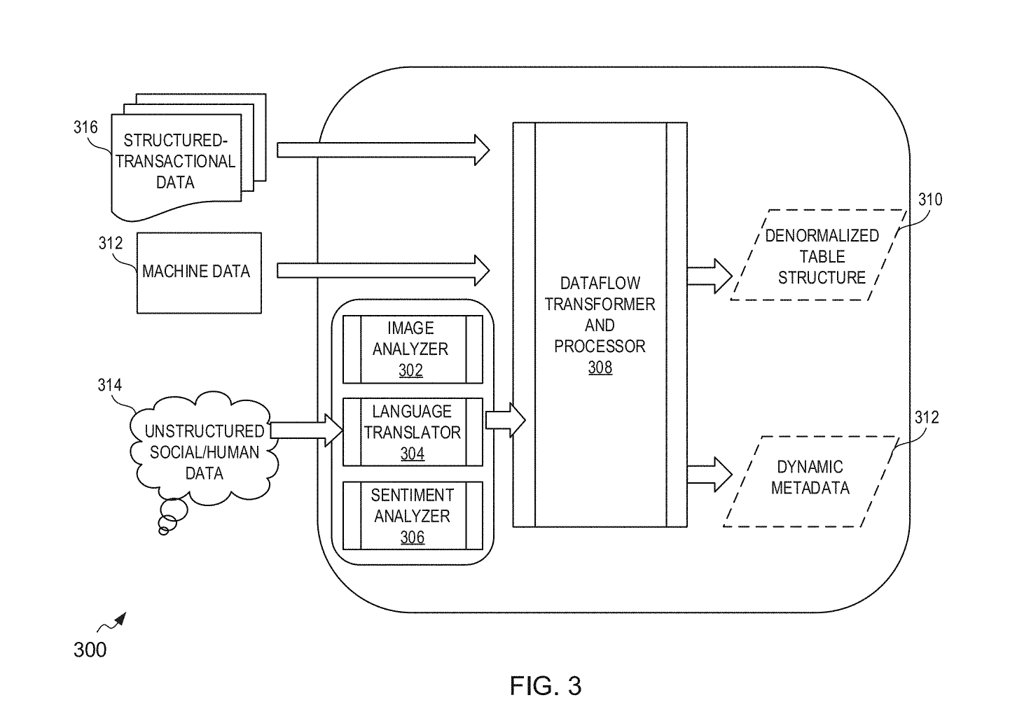

The data input processor 202 receives data from various sources such as including but not limited to machine data 312, which is an example of machine data 104, social data 314 (e.g., text, images, voice), which is an example of human data 102, and transactional data 316 (see FIG. 3). It is to be noted that input data can be obtained from any possible sources which can provide data relevant to the business entities and their associated entities such as suppliers, manufacturers, customers, etc. Also, the input data can be of any suitable type or can carry any information that can be used for making transaction forecast such as demand forecast for any business entity.

In an example, data received from machine sources (e.g. transactional) are structured data while data received from human sources are unstructured data (e.g. speech, expressions, etc.). The data input processor 202 is configured to convert unstructured data related to the business transactions (e.g., demand information, supply information, information about products and services, customer information and pricing information) into structured information. For instance, the unstructured data may be converted to obtain structured texts, images, voices, and/or videos, among other types of data. The structured data may be processed in order to analyze/understand customer's behavior or sentiment towards a product. Such data may be obtained from third party servers and data centers, such as, shopping centers, supermarkets, service centers and customer feedback platforms, social media platforms, among others. As an example, the data input processor 202 may be Google's open source sentiment analysis (of text, speech and visual) to determine customer sentiment, such as, likes, dislikes about products and offerings.

In an example scenario of a retail business input, data streams may include information related to products, customers, location and suppliers, among others. Examples of input data for the retail business may include demand channels, dependent demand channels, product hierarchy, customer hierarchy, location hierarchy, supplier hierarchy, employee hierarchy, time hierarchy, customer/partner master data, product master data, supplier master data, order history, shipment history, market sentiment data, internal price data, competitive price data and target KPIs, among others.

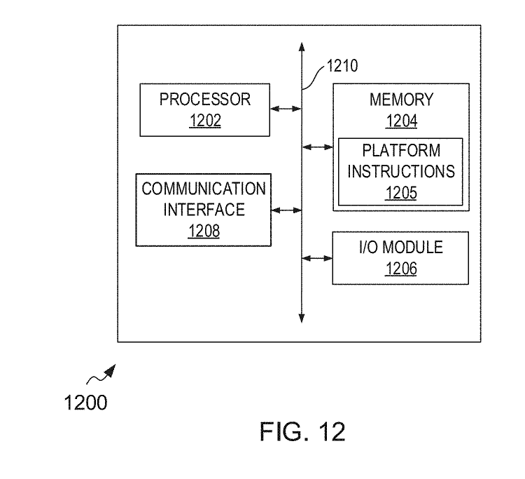

The data input processor 202 uses techniques that enable the ability to manage and store huge data volumes of disparate types at significant speeds. The data input processor 202 handles the complex task of handling multiple streams of different data types and creates the output in a common format that can be analyzed while further processing in a subsequent block. The system 200 stores the plurality of common format input data streams in form of denormalized cell structure and a metadata in a memory (e.g. memory 1204 of FIG. 12).

The pattern search multi stream demand sensor 212 receives the data processed by the data input processor 202, and performs pattern search, trend search and algorithm match. Based on pattern searching, one or more business transaction patterns may be identified in the plurality of input data streams. Business transaction patterns include a demand pattern, a supply pattern and a pricing pattern. To identify business transaction patterns, the pattern search multi demand sensor 212 performs at least one of machine learning, voice recognition, image analysis for sentiment prediction and dynamic translation of the plurality of input data streams. Pattern search handles multiple streams inputs and then arranges them into classified clusters that are related.

The pattern search multi stream demand sensor 212 is configured to classify the plurality of streams of input data based on affinity parameters and arrange them into a plurality of clusters based on the classification. Affinity analysis is performed on the common format input data streams that detect matched customer clusters and associated product clusters. Examples of matched customer clusters and associated product clusters may include customers that tend to buy similar products in similar time periods, customers that tend to buy similar products in similar geographical locations, customers that tend to buy similar products in the same age group, etc. The pattern search multi stream demand sensor 212 generates a plurality of such sets of customer and products clusters based on factors disclosed in the above examples but not limited to them.

The pattern search multi stream demand sensor 212 further performs affinity analysis for automated detection of suppliers and products. The analysis develops matched products or components of products with suppliers. Examples of suppliers and products clusters may include suppliers selling products or suppliers selling similar components of products, etc. The pattern search multi stream demand sensor 212 generates a plurality of such sets of suppliers and offering clusters.

The clusters of customers and products, and suppliers and products may indicate demand and supply patterns. Likewise, a pricing pattern is identified from the plurality of input data streams. The demand pattern may be analyzed for selecting demand forecasting models 110. The supply pattern may be analyzed for selecting supply models 112. The pricing pattern may be used to determine a pricing model 114.

In an example embodiment, the pattern search multi stream demand sensor 212 uses set of instructions defined in “Apriori” or “K-means” form to cluster customers with offerings and suppliers with offerings. Apriori is used for determining the combinations that are most likely to be related, such as combination of products that are most likely to be bought by customer with one another and or in addition are sold by their preferred choice of retailer. K-means may be used in a scenario where a set of relationships of various attributes are to be determined and put in a related cluster with most accuracy.

Output of the pattern search multi stream demand sensor 212 (clusters of input data and demand-supply pattern) and pricing data may be in an example used by the multi-dimensional demand supply balancer 214 to select the best fit forecast model to determine accurate demand model 110, supply model 112 and pricing model 114. The multi-dimensional demand supply balancer 214 is configured to identify demand and supply scenarios and related pricing (customer, predicted demand, predicted supply clusters and pricing band) and leverage a recurrent network based on Tensor flow to come up with the demand model 110, the supply model 112 and the pricing model 114.

In an example embodiment, the recurrent network may use historical information for demand, supply and pricing data to iteratively apply the plurality of forecast model (demand model 110, supply model 112 and pricing model 114) on the identified patterns based at least on historical information associated with the identified patterns, to select the forecast model providing the highest accuracy. In an example, the historical information may be retrieved from relevant sources such as third party servers, data centers, etc. The multi-dimensional demand supply balancer 214 determines the highest forecast accuracy while considering multi-dimensional set of supply (supply chain) parameters with a number of permutations and combinations.

In an example embodiment, the Tensor flow algorithm selects initial set of models based on known data such as historical demand, supply and price information, revenue, cost and profits. All models are run till highest prediction accuracy (e.g. 98+%) is achieved and the results are recorded.

In an example embodiment, the multi-dimensional demand supply balancer 214 may include self-learning forecast algorithm that enables the multi-dimensional demand supply balancer 214 to to select the forecast model providing the highest accuracy. The multi-dimensional demand supply balancer 214 may take all recommendations made by intelligent stream sifting, pattern search and mapping (e.g., from the pattern search multi stream demand sensor 212) and evaluates their impact in terms of the forecast accuracy and also in terms of the settings set for the auto pilot (e.g., received from an auto pilot input center 220) in terms of desired key performance indicators to aim for. The multi-dimensional demand supply balancer 214 may also receive an output of the auto pilot input center 220. The result of the multi-dimensional demand supply balancer 214 is the best fit forecast model deriving the highest forecast accuracy with consideration to key input parameters. In a non-limiting example, the forecast accuracy recommendation is taken by the multi-dimensional demand supply balancer 214 to look at the following:
Demand at various levels and corresponding supply components
Perform multiple iterative “what if decision tree” analysis using desired KPI maps received from the auto pilot input center 220.
Recommended set of data that will drive the key operational activities by the final step in the process.

In an example embodiment, the system 200 determines the present visualization in UI Cockpit for recommendations as well as prepares the data for external triggering (REST API based) for the functions including but not limited to the following functions:
Demand Management
Inventory Planning and Control
Supply Management
Manufacturing Management
Distribution Management
Customer/Partner notifications.

The business transaction forecast output 116 may be actionable input for the business entity. Outputs 114 may be received in human readable form such as tabular representation of data. Other forms of representation may also be displayed, such as a graphical representation. In an example, the output 116 for a retail industry may include recommendation on price, expected demand, offerings, target GM, lowest revenue and expected loss or gain, among others.

FIG. 3 illustrates a portion 300 of the system, such as the system 200 for determining forecast, in accordance with an example embodiment. In one example, the portion 300 represents the data input processor 202. The key differentiation provided by the portion 300 compared to existing data processors is the ability to not only process huge amounts of information at high speeds but also handle structured (e.g., structured transactional data 316 and machine data 312) as well as unstructured social/human data (e.g., social data 314). For instance, instead of just storing the unstructured information, the data input processor 202 performs image analysis of photo and video information using an image analyzer 302 to set digital context that can be used for forecast analysis (e.g., a photo of massive damage at customer site to mark an uptick for infrastructure products). Similarly, the data input processor 202 uses a language translator 304 to make sure that multi language social streams can be analyzed to decipher the impact on demand. The data input processor 202 also uses a sentiment analyzer 306 to perform sentiment analysis to make the corresponding impact marks.

The data input processor 202 includes a data flow transformer and processor 308 which obtains the structured data and processed unstructured data (i.e. output of the image analyzer 302, the language translator 304 and the sentiment analyzer 306). The data flow transformer and processor 308 performs data processing and stores the output in a huge denormalized table structure 310 that will then be used for all further analysis. It is noted that the table structure 310 provided herein is a comprehensive spreadsheet database structure capable of being included within a product core and providing all information that is required for key analyses. In an example, the denormalized data structure may be a single denormalized queryable data store. In one non-limiting implementation, the data is stored using timestamps which are also used for retrieval using a key search approach that results in extremely high speed storage and retrieval. As shown in FIG. 3, a dynamic metadata 312 is also stored.

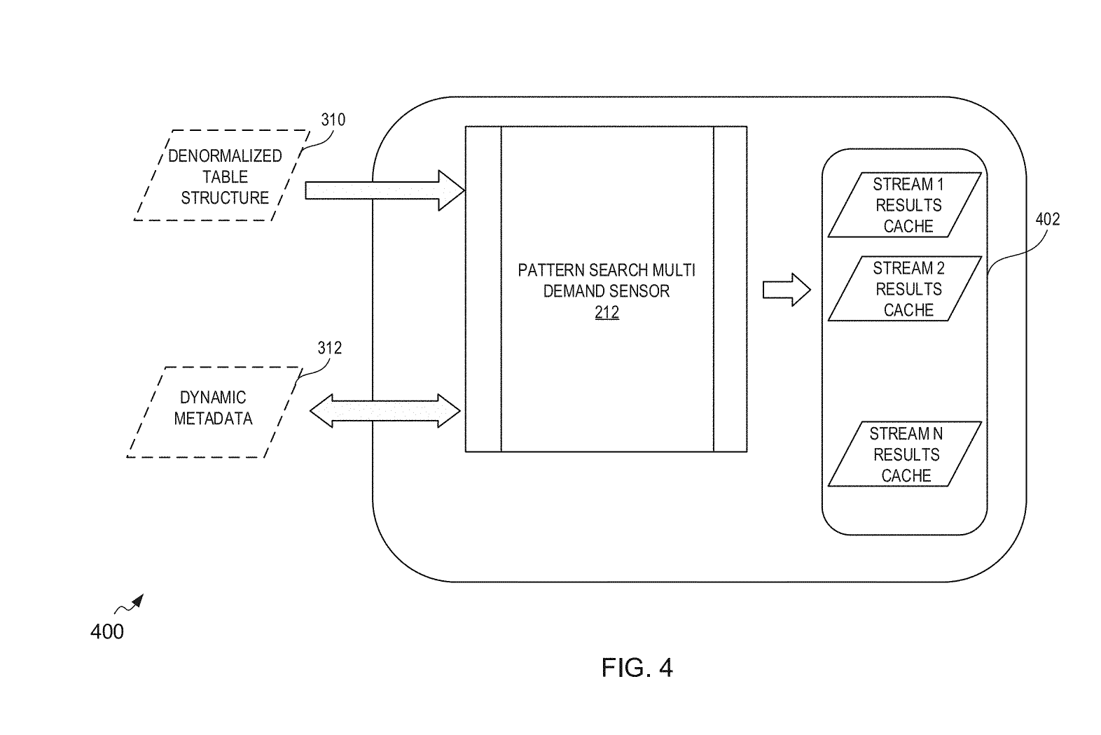

FIG. 4 illustrates another portion 400, such as the pattern search multi demand sensor 212 of the system 200 for determining forecast, in accordance with an example embodiment.

The pattern search multi demand sensor 212 takes the information, i.e. the table structure 310 and the dynamic metadata 312 from the data input processor 202 and builds matched clusters of customers and offerings (e.g., goods/products/services/material) and clusters of suppliers and offerings. The table structure 310 includes formatted data including business transaction data such as orders, shipments, returns, work orders, purchase orders, machine data such as, RFID triggers, Beacon triggers and social data such as RSS feeds from social sources, and the like. The pattern search multi demand sensor 212 may even create derivative streams 402 based on related data between all these three types (e.g., the set of streams formed by the transactional data, the machine data and the social data) as opposed to conventional and current forecasting algorithm fit methods, which consider best fit with only a specified demand stream. The pattern search multi demand sensor 212 is capable of evaluating multiple streams 402, performing best fits and making a recommendation for possible set of outcomes that can be further refined. The further refinement is done as a result of the streams 402 being used by next processor as shown in FIG. 5 below.

FIG. 5 illustrates yet another portion 500, such as multi-dimensional demand supply balancer 214 for determining forecast, in accordance with an example embodiment. The multi-dimensional demand supply balancer 214 takes the streams 402 created by the portion 400 (e.g., the pattern search multi demand sensor 212) and determines the best fit model by comparing various streams 402 in context of the dynamic metadata 312. As noted earlier, the auto pilot input center 220 commands and recommends the best possible set of directives, for example, auto pilot command input (see, arrow 502) for forecast accuracy maintenance which the pattern search multi demand sensor 212 stores in the table structure 310. In addition to not only considering sources which never have been considered for forecast accuracy before, the multi-dimensional demand supply balancer 214 includes self-learning algorithms that provides self-learning capability by modifying the dynamic metadata 312 dynamically to set parameters for future selections.

In various embodiments, the system 200 may be provided as a SaaS solution and set of algorithms including the data model that helps with the continuous improvement of the forecast accuracy. The system 200 is capable of receiving huge volumes of continuous feed of data and interpreting the same data flows in adjusting the forecast accuracy as frequently as needed in business real-time mode. The key driver of the system 200 is the forecast accuracy which is the most critical component of any operations process used by current enterprises serving all industries. The system 200 not only processes huge and multiple streams of data volumes but also uses self-learning techniques to ensure that the model that is most relevant and gives the highest forecast accuracy, is chosen. This in turn drives the demand and supply balancing algorithms that are extremely crucial for operating any business operations process with the maximum efficiency (highest output at most optimized cost). The purpose of the system 200 is to help large enterprises as well as small and medium business customers to improve forecast accuracy of their demand so that they can plan the right amount of supply and thereby improve profitability. The system 200 is capable of taking inputs that are continuously processed with results being processed in near business real-time mode.

The system 200 provides a solution that can be described as “a continuously real time adapting and self-learning-huge data absorbing high accuracy forecasting engine that uses structured (transactional, machine generated) and unstructured data (social, human generated, multimedia). Such data is at the core of a business operations autopilot that is able to sense business impacting inputs and make corresponding process corrections to keep the processes running in a manner that leads to highly predictable business outcomes. The system 200 includes high speed input data processor (e.g., the input data processor 202) that is capable of processing structured and unstructured input data streams and storing it in high performance cloud storage. Such high performance cloud storage can enable processing of billion of rows of information in very less response time say less than 5 seconds. Such type of storing (e.g., one huge denormalized cell structure) enables high speed information storage and retrieval. The denormalized cell structure is then leveraged by the next step (i.e. the multi stream demand sensor 212) that then performs pattern search across multiple streams of data and groups recommendation for output based on multiple groupings or streams of demand. Hence, embodiments of the present disclosure offer selection of the best fit model that is suitable for multiple input data streams and accordingly make a recommendation obtained based on the determined business transaction forecast.

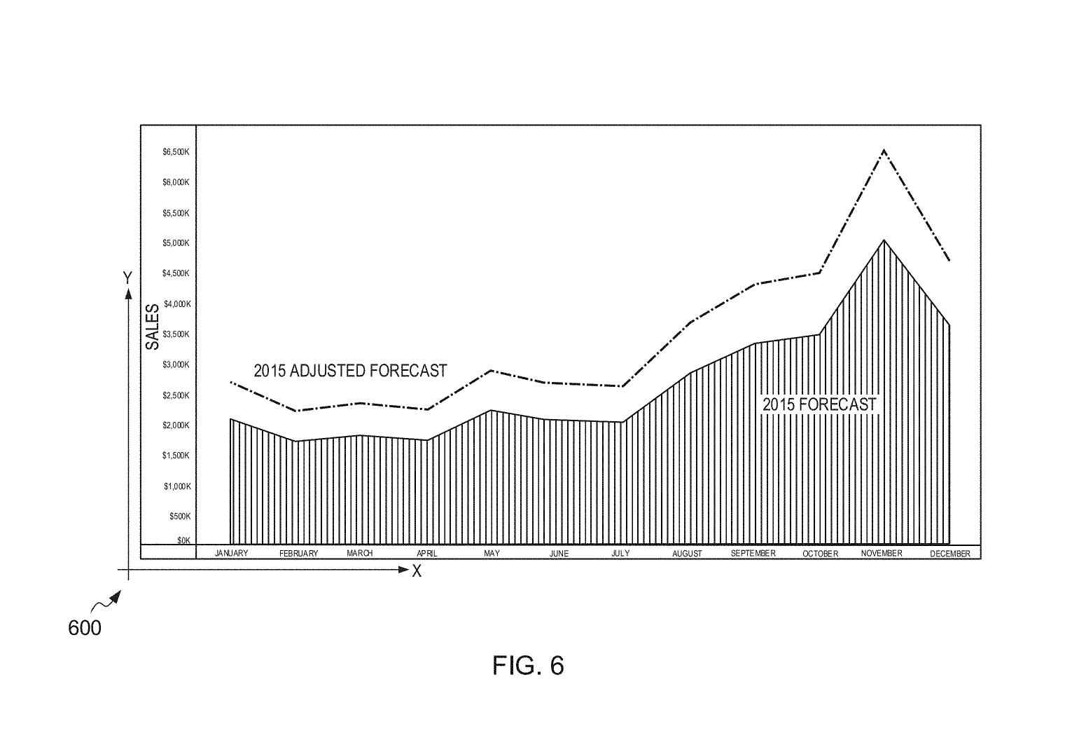

FIG. 6 depicts a plot 600 representing adjusted forecast, in accordance with an example embodiment. A line graph in the plot 600 shows an example representation of a continuous, accurate and automatically determined forecast for year 2015. Specifically, in the plot 600, X axis shows months of the year 2015 and Y axis shows sales in US dollars (S). Based on the forecast, the business entity can adjust its production or supply. The forecast predicted is higher in later months of the year while lesser in beginning months of the year. For instance, in the month of November, sales forecast is the highest.

In an embodiment, the present implementation of the system 200 may be configured to provide recommendations for launch of promotions based on the supply availability. In an example, when there is an excess inventory, recommendation may suggest automatic launch of a promotion with certain discount so that the inventory gets cleared out, while respecting the business goals.

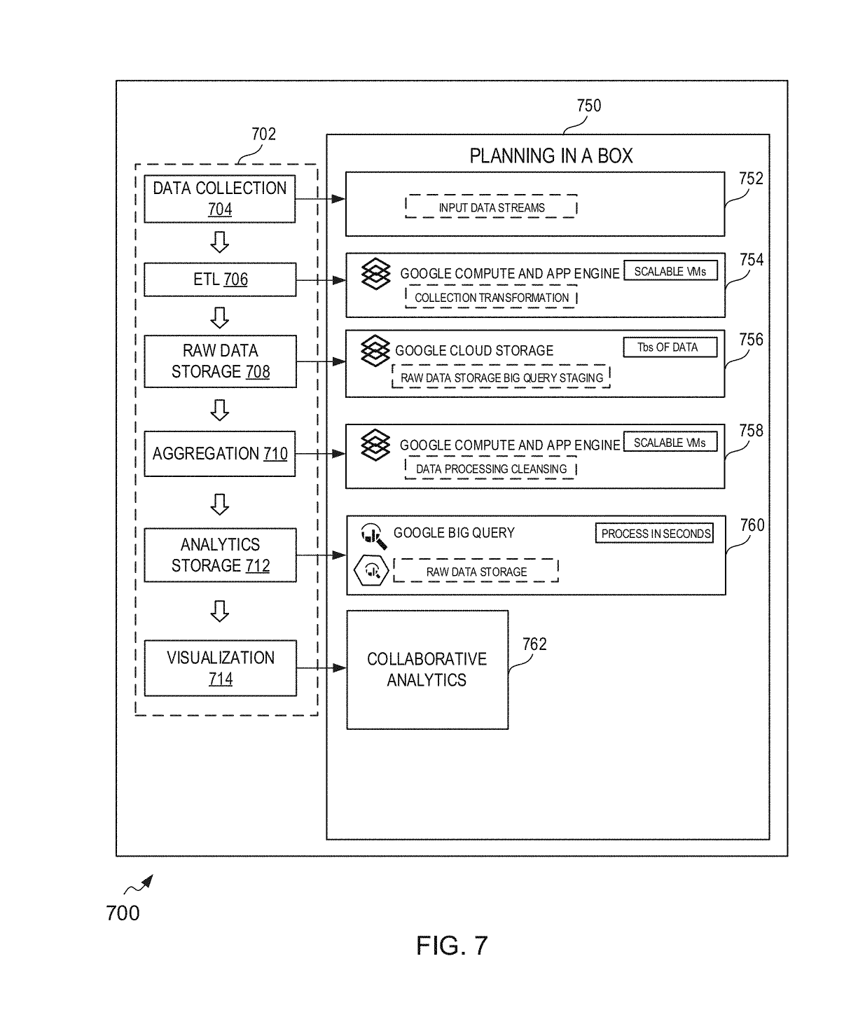

FIG. 7 depicts a simplified representation 700 of the system 200, in accordance with an example embodiment. The representation 700 shows a data flow 702 that includes processes such as data collection 704, Extract Transform and Load (ETL) 706, raw data storage 708, aggregation 710, analytics storage 712 and visualization 714.

The representation 700 shows a box 750 representing environments for performing steps 702 to 714. Without limiting to the scope of the present disclosure, the steps 702 to 714 may be implemented using Google® offerings, i.e. Google® cloud platform (see, representations 752, 754, 756, 758, 760 and 762 of the platform for the steps 704, 706, 708, 710, 712 and 714, respectively). As shown in FIG. 7, the representation 762 shows the actionable analytics that in human readable format, for example graphic plots.

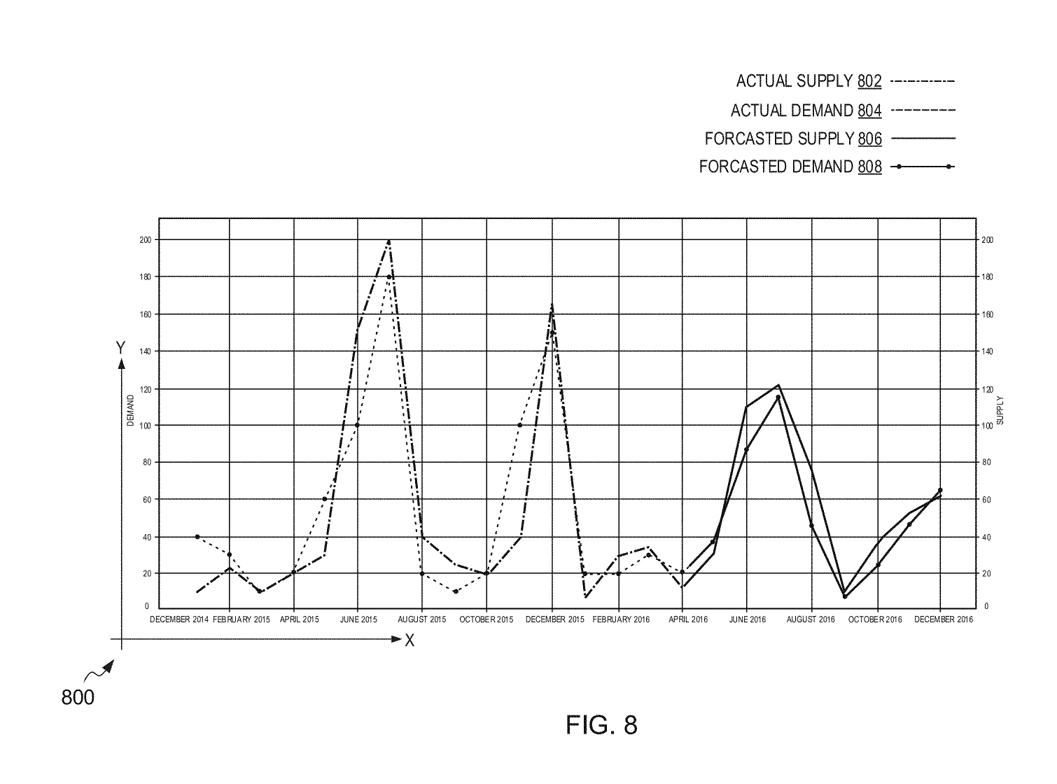

FIG. 8 depicts a plot 800 representing high accuracy output produced by the system such as the system 200, in accordance with an example embodiment. The plot 800 shows forecast for various streams, in which X axis shows months and Y axis shows demand Two graph lines, i.e. an actual demand graph line 802 and an actual supply graph line 804 show actual values for demand and supply till April 2016. In this example representation, post April 2016, the graph lines (e.g., forecasted demand 806 and forecasted supply 808) are generated using the system 200.

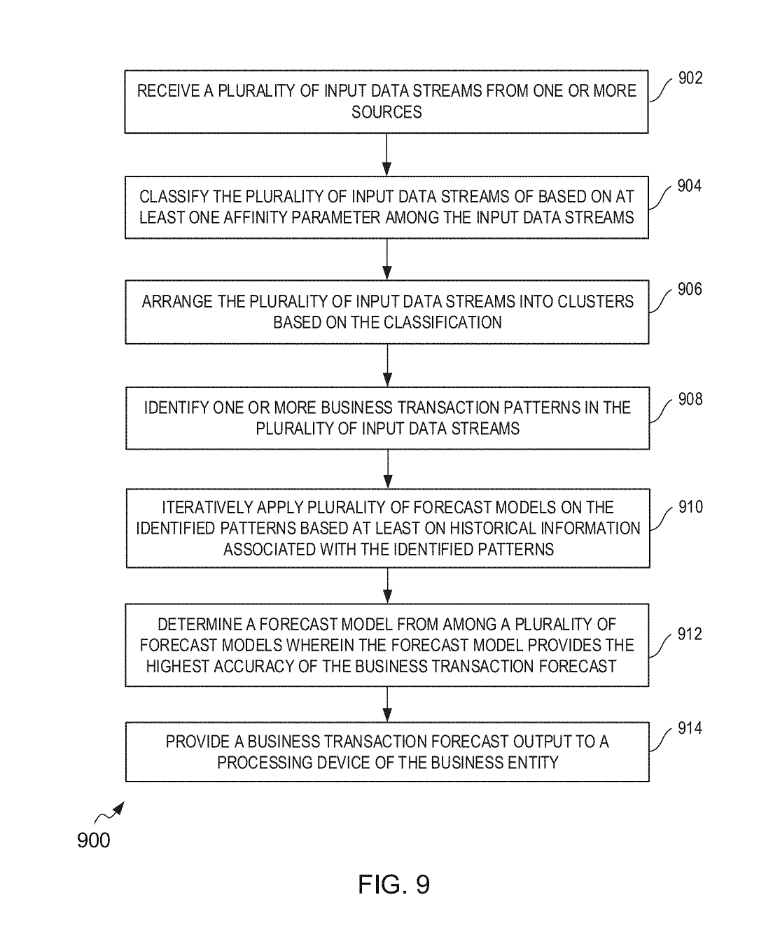

FIG. 9 is an illustration of a method 900 for determining business transaction forecast for a business entity, in accordance with an embodiment. Method 900 is carried out by the system 200 and includes a sequence of steps. The sequence of operations of the method 900 may not be necessarily executed in the same order as they are presented. Further, one or more steps may be grouped together and performed in form of a single step, or one step may have several sub-steps that may be performed in parallel or in sequential manner by processing elements present in the system 200.

At operation 902, a plurality of streams of input data from one or more sources are received by the data input processor 202. At operation 904 (optional step), input data present in the plurality of input data streams are classified based on at least one affinity parameter among the input data by the pattern search multi stream demand sensor 212. At operation 906 (optional step), the pattern search multi stream demand sensor 212 arranges the plurality of input data streams into clusters based on the classification. At operation 908, one or more business transaction patterns for example demand, supply and related pricing patterns are identified. At operation 910, one or more forecast models are iteratively applied on the identified patterns based on historical information associated with one or more demand, supply and pricing patterns identified at the previous operation 908. At operation 912, a forecast model among all the forecast models, is determined such that the forecast accuracy of the determined model has the highest accuracy of the business transaction forecast among all models. At operation 914, a business transaction forecast output is provided to a processing device of a business entity in human readable form, such that the output complies with the selected model.

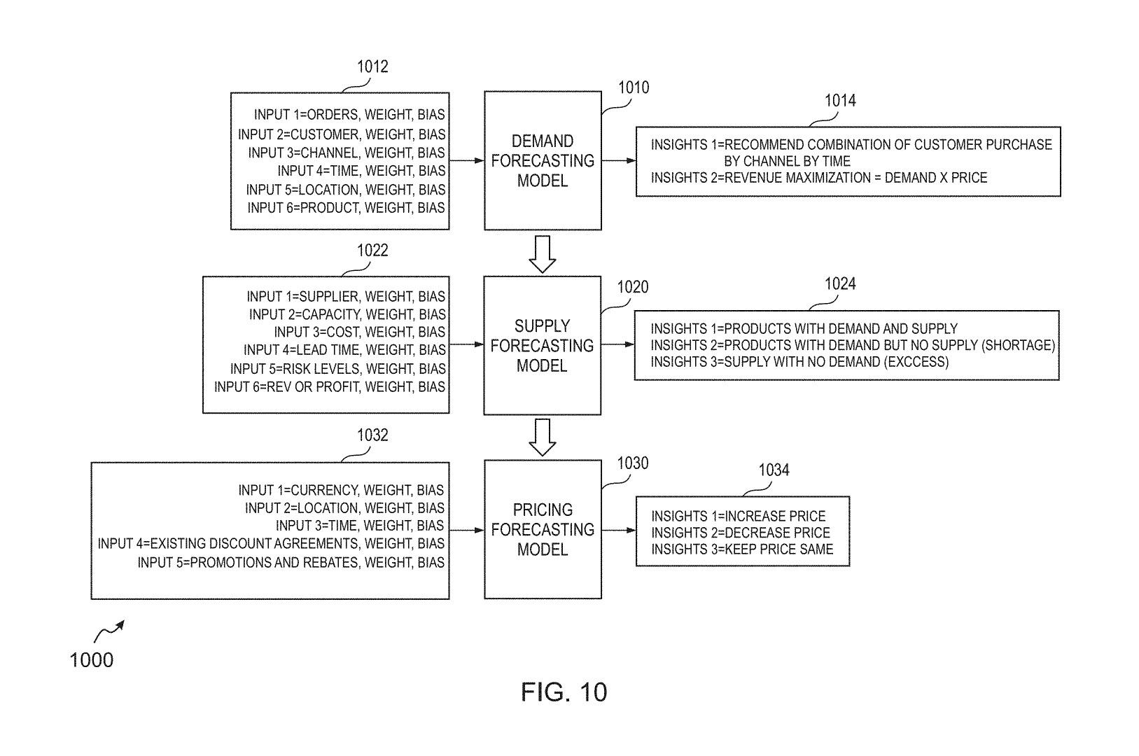

FIG. 10 is a simplified representation 1000 of a sequence flow for selecting demand, supply and pricing models, in accordance with an embodiment. The sequence flow can be executed by the system 200 as described with reference to one or more of the preceding figures.

As shown in the representation 1000, a demand forecasting model 1010 (an example of the demand model 110), a supply forecasting model 1020 (an example of the supply model 112) and a pricing forecasting model 1030 (an example of the pricing model 114) are shown. The demand forecasting model 1010 takes inputs from multiple input data streams (see, 1012) and provides business transaction forecast output (see, 1014). For instance, the demand forecasting model 1010 receives inputs 1012 corresponding to customers, products, location, time, channels, etc. Some non-exhaustive examples of the inputs 1012 include the following:
Input 1—Orders, Weight, Bias
Input 2—Customer, Weight, Bias
Input 3—Channel, Weight, Bias
Input 4—Time, Weight, Bias
Input 5—Location, Weight, Bias
Input 6—Product, Weight, Bias

The demand forecasting model 1010 provides the outputs 1014 inform of recommendations/insights, as given below:
Insight 1—Recommend combination of customer product purchase by channel by time
Insight 2—Revenue maximization as demand multiplied by price.

Similarly, the supply forecasting model 1020 receives inputs 1022 corresponding to suppliers, capacity, lead time, risk levels, etc. Some non-exhaustive examples of the inputs 1022 include the following:
Input 1—Supplier, Weight, Bias
Input 2—Capacity, Weight, Bias
Input 3—Cost, Weight, Bias
Input 4—Lead time, Weight, Bias
Input 5—Risk Levels, Weight, Bias
Input 6—Revenue or profit, Weight, Bias

The supply forecasting model 1020 provides the outputs 1024 inform of recommendations/insights, as given below:
Insight 1—Products with demand and supply
Insight 2—Products with demand but no supply (shortage)
Insight 3—Supply with no demand (excess)

Similarly, the pricing forecasting model 1030 receives inputs 1032 corresponding to currency, location, time, Existing discount agreements, promotions etc. Some non-exhaustive examples of the inputs 1032 include the following:
Input 1—Currency, Weight, Bias
Input 2—Location, Weight, Bias
Input 3—Time, Weight, Bias
Input 4—Existing discount agreements, Weight, Bias
Input 5—Promotions and rebates, Weight, Bias

The pricing forecasting model 1030 provides the outputs 1034 inform of recommendations/insights, as given below:
Insight 1—Increase price
Insight 2—Decrease price
Insight 2—Keep price same

As shown in FIG. 10, these models can be executed in a sequential manner, for example the demand forecasting model 1010, the supply forecasting model 1020 followed by the pricing forecasting model 1030. However, such configurations should be considered as limiting to the scope of the present disclosure, and these models can be executed in parallel or as a single operation. In an embodiment, the retail industry may be required to calculate the net demand so as to adjust the supply depending on the product demand and the shelf stocks. The calculated net product demand and adjusted supply, in turn, may be used to calculate a component demand and supply requirement and the shortage or excess of components.

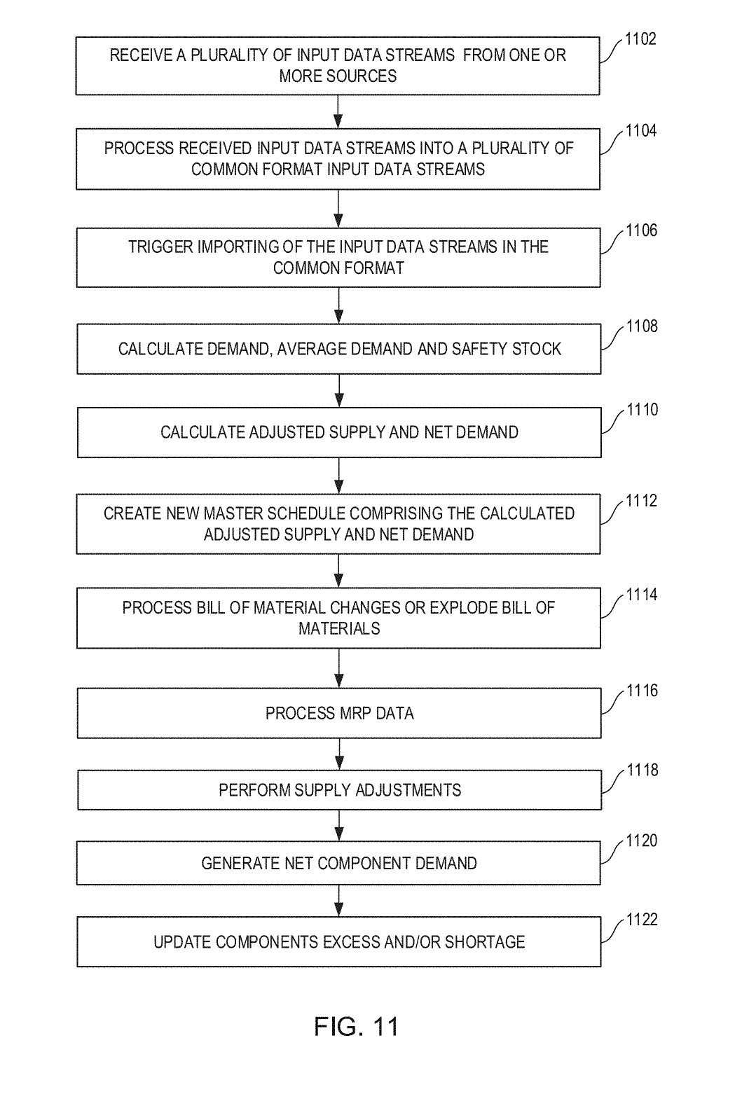

FIG. 11 is an illustration of a flow diagram of a method 1100 of calculating net demand and adjusted supply of products and providing recommendations, in accordance with an embodiment. At operation 1102, a plurality of input data streams are received from various sources. The plurality of input data streams may include data from sources such as humans, machines or transactional data as described with reference to FIGS. 1 to 2. The input data may include customer related information, supplier related information, product related information and pricing related information, wherein the customer related information, supplier related information, product related information and pricing related information are associated with the business entity for which the business transaction forecast is to be determined.

At operation 1104, received input data streams are processed into a plurality of common format input data streams. The input data streams in the common format are stored in the form of denormalized cell structure and metadata as described with reference to FIG.3. At operation 1106, importing of the input data streams in the common format is triggered. The input data streams may be processed to identify business transaction patterns including demand pattern, supply pattern and pricing pattern. At operation 1108, demand, average demand and safety stock are calculated. At operation 1110, adjusted supply and net demand are calculated. At operation 1112, a new master schedule comprising the calculated adjusted supply and net demand are created. The master schedule comprises information on the net demand of products, adjusted supply based on the demand, etc. At operation 1114, bill of material (BOM) changes is processed based on the net demand and the adjusted supply and the maximum retail price (MRP) is processed at the next operation 1116. At operation 1118, supply adjustment is performed. Net component demand is generated at operation 1120. Finally at operation 1122, the excess and/or shortage of components is calculated and corresponding recommendation is sent to the business entity.

FIG. 12 depicts an example system 1200 for determining forecast, in accordance with an example embodiment. In an implementation, the system 1200 may be example of the system 200 or any system that is capable of performing the teaching described in various embodiments of the present disclosure. The system 1200 includes at least one processor such as a processor 1202 and at least one memory such as a memory 1204. The system 1200 also includes an I/O module 1206 and a communication interface 1208. The system 1200 can be embodied in a server or in a client device.

Although the system 1200 is depicted to include only one processor 1202, the system 1200 may include more number of processors therein. In an embodiment, the memory 1204 is capable of storing platform instructions 1205, where the platform instructions 1205 are machine executable instructions associated with determining forecast. In an embodiment, the memory 1204 may store the demand models 110, the supply models 112 and the pricing models 114. Further, the processor 1202 is capable of executing the stored platform instructions 1205. In an embodiment, the processor 1202 may be embodied as a multi-core processor, a single core processor, or a combination of one or more multi-core processors and one or more single core processors. For example, the processor 1202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 1202 may be configured to execute hard-coded functionality. In an embodiment, the processor 1202 is embodied as an executor of software instructions, wherein the instructions may specifically configure the processor 1202 to perform the algorithms and/or operations described herein when the instructions are executed.

The memory 1204 may be embodied as one or more volatile memory devices, one or more non-volatile memory devices, and/or a combination of one or more volatile memory devices and non-volatile memory devices. For example, the memory 1204 may be embodied as magnetic storage devices (such as hard disk drives, floppy disks, magnetic tapes, etc.), optical magnetic storage devices (e.g., magneto-optical disks), CD-ROM (compact disc read only memory), CD-R (compact disc recordable), CD-R/W (compact disc rewritable), DVD (Digital Versatile Disc), BD (Blu-ray® Disc), and semiconductor memories (such as mask ROM, PROM (programmable ROM), EPROM (erasable PROM), Phase-change memory, flash ROM, RAM (random access memory), etc.).

The system 1200 also includes an input/output module 1206 (hereinafter referred to as ‘I/O module 1206’) for providing an output and/or receiving an input. The I/O module 1206 is configured to be in communication with the processor 1202 and the memory 1204. Examples of the I/O module 1206 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 1202 may include I/O circuitry configured to control at least some functions of one or more elements of the I/O module 1206, such as, for example, a speaker, a microphone, a display, and/or the like. The processor 1202 and/or the I/O circuitry may be configured to control one or more functions of the one or more elements of the I/O module 1206 through computer program instructions, for example, software and/or firmware, stored on a memory, for example, the memory 1204, and/or the like, accessible to the processor 1202.

In an embodiment, the I/O module 1206 may be configured to provide a user interface (UI) configured to provide options or any other display to a user of the system 1200. Also, the I/O module 1206 may be integrated with mechanisms configured to receive inputs from the user of the system 1200.

The communication interface 1208 may enable the system 1200 to communicate with other devices (e.g., data processing or computing device of business entities) and the server. The communication interface 1208 may be configured to communicate to various types of networks.

In an embodiment, various components of the system 1200, such as the processor 1202, the memory 1204, the I/O module 1206 and the communication interface 1208 are configured to communicate with each other via or through a centralized circuit system 1210. The centralized circuit system 1210 may be various devices configured to, among other things, provide or enable communication between the components (1202-1208) of the system 1200. In certain embodiments, the centralized circuit system 1210 may be a central printed circuit board (PCB) such as a motherboard, a main board, a system board, or a logic board. The centralized circuit system 1210 may also, or alternatively, include other printed circuit assemblies (PCAs) or communication channel media.

It is understood that the system 1200 as illustrated and hereinafter described is merely illustrative of a system that could benefit from embodiments of the disclosure and, therefore, should not be taken to limit the scope of the disclosure. It is noted that the system 1200 may include fewer or more components than those depicted in FIG. 12.

In an embodiment, the system 1200 may be implemented as a platform including a mix of existing open systems, proprietary systems and third party systems. In another embodiment, the system 1200 may be implemented completely as a platform including a set of software layers on top of existing hardware systems. In an embodiment, one or more components of the system 1200 may be deployed in a web server. In another embodiment, the system 1200 may be a standalone component in a remote machine connected to a communication network and capable of executing a set of instructions (sequential and/or otherwise). Moreover, the system 1200 may be implemented as a centralized system, or, alternatively, the various components of the system 1200 may be deployed in a distributed manner while being operatively coupled to each other. In an embodiment, one or more functionalities of the system 1200 may also be embodied as a client within devices. In another embodiment, the system 1200 may be a central system that is shared by or accessible to each of such devices.

For example, the forecasting systems disclosed in the present disclosure such as the system 200 provide following features:
Ability to process huge amounts of data input from multiple sources
Huge amount of data processed via large scale machine learning
Ability to translate multimedia data input into decision making criteria (example image sentiment analysis, speech recognition utilities)
Self-learning algorithm for effective pattern determination, matching, selection
Best fit forecasting formula selection based on input
Supply Demand Balancing algorithm
Forecast to Actual comparison
Forecast improvement tracking
Forecast Generation
Machine data feeds adjusting forecasts
Human data feeds adjusting forecasts
Ability to present information in multiple languages using agile dynamic translation.

In some example embodiments, the system 200 includes any suitable combination of following components for providing above mentioned features:
Cloud platform
Automated deployment capability (application launcher)
Image processing with sentiment analysis
Large scale machine learning
Speech recognition
Dynamic translate utilities
Highly scalable data processing model
Business oriented data input capability
Business oriented data output capability
Business oriented desired result selection cockpit
Actionable triggers and visualization for appropriate human override (Business oriented command and control with sophisticated visualizations)
State of the art multi-purpose Data Model
State of the art algorithms encapsulated in application, container, docker model following the kubernete model.

Without in any way limiting the scope, interpretation, or application of the claims appearing below, a technical effect of one or more of the example embodiments disclosed herein is to provide forecast determination continuously, accurately, and automatically. In addition, at least some advantages of the present disclosure include ability to input massive amount of data, ability to process massive amount of data, ability to have self-learning algorithms that maintain high forecast accuracy, ability of forecast accuracy auto-pilot to continuously get feeds from human and machine data and improve forecast accuracy, ability to provide auto-pilot capability for a business process via actionable triggers that are business real-time, ability to reduce human labor involved in managing forecast accuracy, ability to provide a visual aid on the overall impact to the demand and supply with the adjusted forecast and there by the value chain impact visibility, and ability to tie the forecast accuracy to desired result indicators for the business processes. Further, various embodiments of the present disclosure have ability to provide single visual that showcases the impact of forecast accuracy across value chain, ability to input large data volumes from multitude of data sources (not limited to machine data, social data, transactional data), ability to execute highly sophisticated pattern search, pattern match, pattern recognition algorithms involving enormous amounts of data in business real-time, ability to execute self-learning algorithms to enable selection of the right predictive formulae that result in highest forecasting accuracy without the interaction of a human being, ability for continuous improvement of forecast accuracy using machine learning and machine data along with human data with a feature “Forecast Accuracy Auto Pilot”, ability to leverage the impacts of the forecast accuracy improvement across the value chain example but not limited to demand (opportunity, sales order), supply, components planning, delivery and revenue plan with appropriate signals for human intervention based on selected set of desired result parameters, and ability to handle continuous feed of machine data and data from other sources (including non-traditional sources) to improve forecast accuracy and have it drive related business operations processes

The present disclosure is described above with reference to block diagrams and flowchart illustrations of method and system embodying the present disclosure. It will be understood that various block of the block diagram and flowchart illustrations, and combinations of blocks in the block diagrams and flowchart illustrations, respectively, may be implemented by a set of computer program instructions. These set of instructions may be loaded onto a general purpose computer, special purpose computer, or other programmable data processing apparatus to cause a device, such that the set of instructions when executed on the computer or other programmable data processing apparatus create a means for implementing the functions specified in the flowchart block or blocks. Although other means for implementing the functions including various combinations of hardware, firmware and software as described herein may also be employed.

Various embodiments described above may be implemented in software, hardware, application logic or a combination of software, hardware and application logic. The software, application logic and/or hardware may reside on at least one memory, at least one processor, an apparatus or, a non-transitory computer program product. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a system described and depicted in FIG. 12. A computer-readable medium may comprise a computer-readable storage medium that may be any media or means that can contain or store the instructions for use by or in connection with an instruction execution system, apparatus, or device, such as a computer.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application \or implementation without departing from the spirit or scope of the claims.

What is claimed is:

1. A computer-implemented method for determining a business transaction forecast, the method comprising:
receiving a plurality of input data streams from one or more sources, the plurality of input data streams comprising at least one of demand information and supply information associated with a business entity for which the business transaction forecast is to be determined;
determining one or more business transaction patterns in the plurality of input data streams;
determining a forecast model from among a plurality of forecast models upon determination of the one or more business transaction patterns, wherein the forecast model provides highest accuracy of the business transaction forecast among the plurality of forecast models; and
providing, a business transaction forecast output generated based on the forecast model to a processing device of the business entity.

2. The method as claimed in claim 1, wherein the plurality of input data streams further comprises pricing information associated with the business entity.

3. The method as claimed in claim 2, wherein the business transaction forecast output is one or more of a demand forecast output, a supply forecast output and a pricing forecast output associated with the business entity.

4. The method as claimed in claim 2, wherein the plurality of input data streams comprises one or more streams of unstructured input data and one or more streams of structured data.

5. The method as claimed in claim 1, further comprising processing the plurality of input data streams into a plurality of common format input data streams, wherein the one or more business transaction patterns are determined in the plurality of common format input data streams.

6. The method as claimed in claim 5, further comprising storing the plurality of common format input data streams in form of denormalized cell structure and a metadata.

7. The method as claimed in claim 1, wherein determining the one or more business transaction patterns in the plurality of input data streams comprises performing at least one of: machine learning, voice recognition, image analysis for sentiment prediction and dynamic translation of the plurality of input data streams.

8. The method as claimed in claim 1, wherein determining the one or more business transaction patterns further comprises classifying the plurality of input data streams into a plurality of clusters based on applying at least one affinity parameter among the plurality of input data streams.

9. The method as claimed in claim 8, wherein determining the forecast model comprises:
receiving an auto pilot command input, the auto pilot command input being a set of directives for forecast accuracy;
identifying a demand pattern, a supply pattern and a pricing pattern from the plurality of clusters; and
iteratively applying the plurality of forecast models on the identified patterns based at least on historical information associated with the identified patterns and the auto pilot command input to select the forecast model providing the highest accuracy.

10. The method as claimed in claim 9, wherein iteratively running forecast models comprises running forecast models using a recurrent network based on tensor flow.

11. The method as claimed in claim 1, wherein determining the one or more business transaction patterns and determining the forecast model further comprise:
determining customer sentiment based on performing a sentiment analysis on the plurality of input data streams;
determining matched customer clusters and associated product clusters;
determining the one or more business transaction patterns using a recurrent network based on tensor flow on the matched customer cluster and associated product clusters.

12. The method as claimed in claim 1, wherein the business transaction forecast output is in human readable form and comprises actionable inputs for the business entity.

13. A system for determining a business transaction forecast, the system comprising:
a processing unit configured to:
receive a plurality of input data streams from one or more sources, the plurality of input data streams comprising at least one of demand information and supply information associated with a business entity for which the business transaction forecast is to be determined;
determine one or more business transaction patterns in the plurality of input data streams;
determine a forecast model from among a plurality of forecast models upon determination of the one or more business transaction patterns, wherein the forecast model provides highest accuracy of the business transaction forecast among the plurality of forecast models; and
provide a business transaction forecast output generated based on the forecast model to a processing device of the business entity; and
a memory configured to:
store the plurality of input data streams in a common format in form of denormalized cell structure and a metadata; and
store the plurality of forecast models.

14. The system as claimed in claim 13, wherein the plurality of input data streams further comprises pricing information associated with the business entity.

15. The method as claimed in claim 14, wherein the business transaction forecast output is one or more of a demand forecast output, a supply forecast output and a pricing forecast output associated with the business entity.

16. The method as claimed in claim 13, wherein the plurality of input data streams comprises one or more streams of unstructured input data and one or more streams of structured data.

17. The system as claimed in claim 16, wherein the one or more streams of unstructured input data and one or more streams of structured data comprises data from one or more sources including human sources and machine sources.

18. The system as claimed in claim 13, wherein the processing unit is configured to perform at least one of machine learning, voice recognition, image analysis for sentiment prediction and dynamic translation of the plurality of input data streams to determine the one or more business transaction patterns in the plurality of input data streams.

19. The system as claimed in claim 13, wherein the memory is configured to store plurality of demand models, supply models and pricing models.

20. The system as claimed in claim 13, wherein the processing unit further comprises a pattern search multi demand sensor configured to classify the plurality of input data streams into a plurality of clusters based on applying at least one affinity parameter among the plurality of input data streams.

21. The system as claimed in claim 20, wherein the processing unit is further configured to:
identify a demand pattern, a supply pattern and a pricing pattern from the plurality of clusters; and
iteratively apply the plurality of forecast models on the identified patterns based at least on historical information associated with the identified patterns to select the forecast model providing the highest accuracy.

22. The system as claimed in claim 21, wherein the processing unit is configured to run forecast models using a recurrent network based on tensor flow.

23. The system as claimed in claim 22 wherein the memory is further configured to store results derived from running the forecast models.

24. The system as claimed in claim 13, wherein the processing unit, while determining the one or more business transaction patterns and determining the forecast model, is configured to:
determine customer sentiment based on performing a sentiment analysis on the plurality of input data streams;
determine matched customer clusters and associated product clusters;
determine the one or more business transaction patterns based on using a recurrent network based on tensor flow on the matched customer cluster and associated product clusters.

25. The system as claimed in claim 13, wherein the business transaction forecast output in human readable form and comprises actionable inputs for the business entity.

26. A system for determining business transaction forecast, the system comprising:
an input data processor configured to:
receive a plurality of input data streams from one or more sources, the plurality of input data streams comprising at least one of demand information and supply information associated with a business entity for which the business transaction forecast is to be determined; and
process at least a portion of the plurality of input data streams into a common format in form of denormalized cell structure and a metadata; and
a pattern search multi demand sensor configured to:
classify the plurality of input data streams into a plurality of clusters based on applying at least one affinity parameter among the plurality of input data streams;
determine one or more business transaction patterns in the plurality of input data streams; and
a multi-dimensional demand supply balancer configured to iteratively apply a plurality of forecast models on the one or more business transaction patterns based at least on historical information associated with the one or more business transaction patterns to select a forecast model providing highest accuracy among the a plurality of forecast models.
